(19) United States
(12) Patent Application Publication
(10) Pub. No.: US 2024/0111995 A1
(43) Pub. Date: Apr. 4, 2024

(54) PREDICTING FUTURE POSSIBILITY OF BIAS IN AN ARTIFICIAL INTELLIGENCE MODEL

(71) Applicant: International Business Machines Corporation, Armonk, NY (US)

(72) Inventors: Manish Anand Bhide, Hyderabad (IN); Prateek Goyal, Indore (IN)

(21) Appl. No.: 17/937,876

(22) Filed: Oct. 4, 2022

(51) Int. Cl. G06N 3/04; G06N 3/08

(52) U.S. Cl. CPC G06N 3/0454; G06N 3/088

(57) ABSTRACT

One or more systems, devices, computer program products and/or computer-implemented methods of use provided herein relate to predicting bias in an artificial intelligence (AI) model. A system can comprise a memory configured to store computer executable components; and a processor configured to execute the computer executable components stored in the memory, wherein the computer executable components can comprise a data generation component that can generate a set of structured test data to test likelihood of an AI model generating biased outputs, based on analysis of payload logging data; and an alerting component that can alert a user of likelihood that the AI model will generate the biased outputs, wherein the alerting component can generate an alert in response to at least a first set of records approaching a defined threshold.

### BACKGROUND

The subject disclosure relates to machine learning and, more specifically, to predicting future possibility of bias in an artificial intelligence (AI) model.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable prediction of future possibility of bias in an AI model are discussed.

According to an embodiment, a computer-implemented system is provided. The computer-implemented system can comprise a memory configured to store computer executable components; and a processor configured to execute the computer executable components stored in the memory, wherein the computer executable components can comprise a data generation component that can generate a set of structured test data to test likelihood of an artificial intelligence (AI) model generating biased outputs, based on analysis of payload logging data; and an alerting component that can alert a user of likelihood that the AI model will generate the biased outputs.

According to another embodiment, a computer-implemented method is provided. The method can comprise generating, by a system operatively coupled to a processor, a set of structured test data to test likelihood of an AI model generating biased outputs, based on analysis of payload logging data; and generating, by the system, alerts to a user of likelihood that the AI model will generate the biased outputs.

According to yet another embodiment, a computer program product for predicting bias in an AI model is provided. The computer program product can comprise a computer readable storage medium having program instructions embodied therewith, the program instructions executable by a processor to cause the processor to generate, by the processor, a set of structured test data to test likelihood of the AI model generating biased outputs, based on analysis of payload logging data; and generate, by the processor, alerts to a user of likelihood that the AI model will generate the biased outputs.

### DESCRIPTION OF THE DRAWINGS

FIG. 1 illustrates a block diagram of an example, non-limiting system that can predict future possibility of bias in an AI model in accordance with one or more embodiments described herein.

FIG. 2 illustrates an example, non-limiting flow-diagram of a baseline distribution-based approach for predicting bias in an AI model in accordance with one or more embodiments described herein.

FIG. 3 illustrates an example, non-limiting flow-diagram of a payload analysis-based approach for predicting bias in an AI model in accordance with one or more embodiments described herein.

FIG. 4 illustrates a block diagram of an example, non-limiting method for predicting future possibility of bias in an AI model in accordance with one or more embodiments described herein.

FIG. 5 illustrates a block diagram of another example, non-limiting method for predicting future possibility of bias in an AI model in accordance with one or more embodiments described herein.

FIG. 6 illustrates a block diagram of an example, non-limiting, operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Bias in AI models is a well-known and well researched problem, and it is a deal-breaker in most scenarios wherein the AI models are deployed into production for actual business use cases. AI models can exhibit bias at any time and detecting and mitigating bias at run-time can defeat the purpose of having an AI model that users can trust. Thus, while techniques may be available for detecting and mitigating bias at runtime after an AI model has exhibited bias, it is desirable to be able to predict beforehand whether an AI model is expected to exhibit in the near future so that the bias can be proactively avoided altogether for fair and trusted AI applications. Bias detected at runtime, can be time-consuming to repair or correct. One or more embodiments discussed herein can predict if an AI model is likely to exhibit bias in the future and give an advanced warning.

Further, AI models are vetted and tested, and several types of tests, including precision tests, accuracy tests, recall tests, bias tests, drift tests, etc., are run on AI models before deploying them in production. However, many AI models exhibit bias at runtime despite of extensive testing, which indicates that there is potential to improve quality of test data sets used to check for bias in the AI models before deployment. Thus, it is also desirable to generate accurate test data sets specific for bias checking so that any possibility of an AI model exhibiting bias is detected at the time of testing. One or more embodiments discussed herein can enable generating a test data set specifically for checking bias in an AI model before deploying the AI model after the AI model is trained or re-trained.

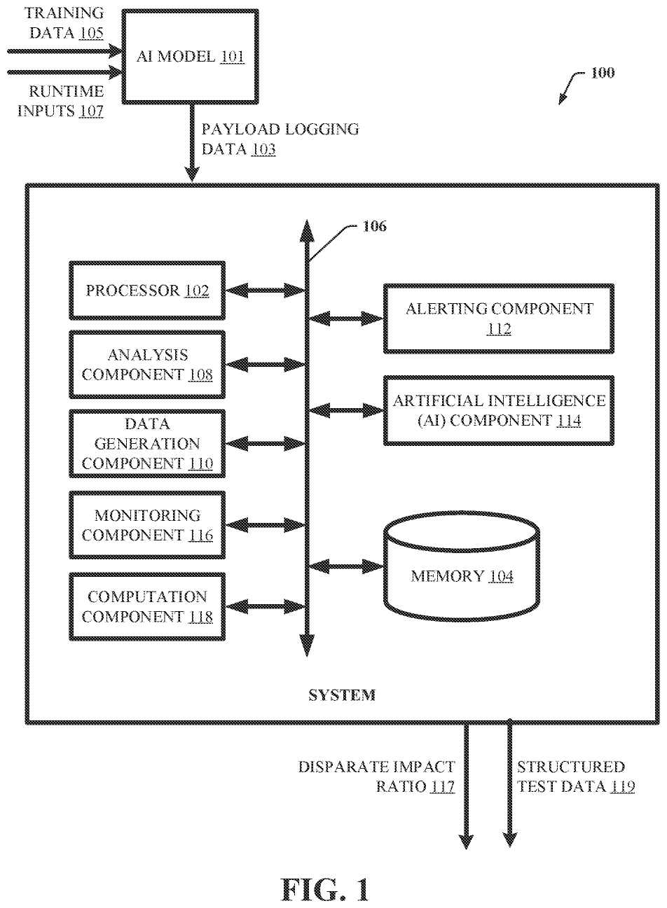

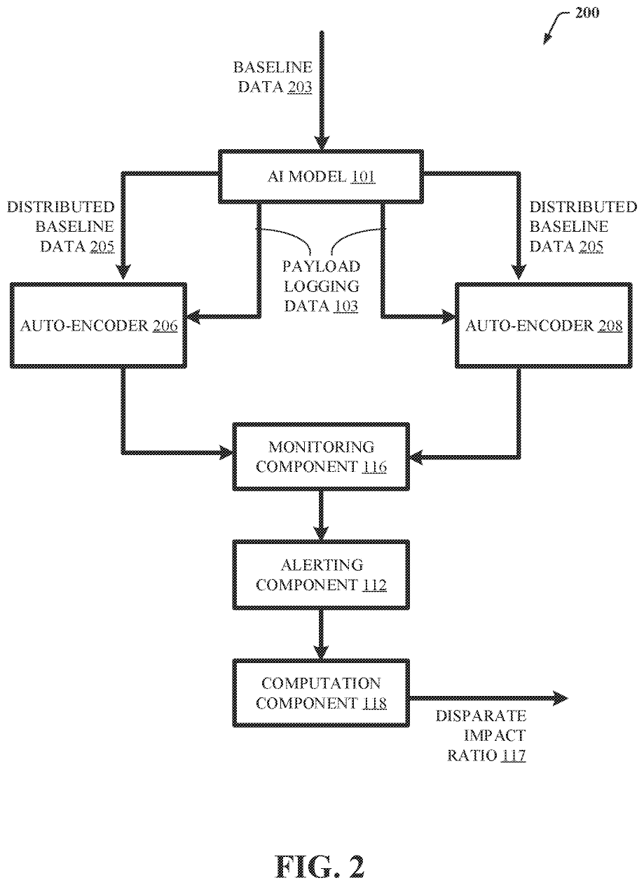

FIG. 1 illustrates a block diagram of an example, non-limiting system 100 that can predict future possibility of bias in an AI model in accordance with one or more embodiments described herein. System 100 can comprise processor 102, memory 104, system bus 106, analysis component 108, data generation component 110, alerting component 112, AI component 114, monitoring component 116, and computation component 118. One or more aspects of the non-limiting system 100 can be described in conjunction with one or more embodiments of FIG. 2.

Discussion first turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., analysis component 108, data generation component 110, alerting component 112, AI component 114, monitoring component 116, and/or computation component 118) to perform one or more actions. In one or more embodiments, memory 104 can store computer-executable components (e.g., analysis component 108, data generation component 110, alerting component 112, AI component 114, monitoring component 116, and/or computation component 118).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

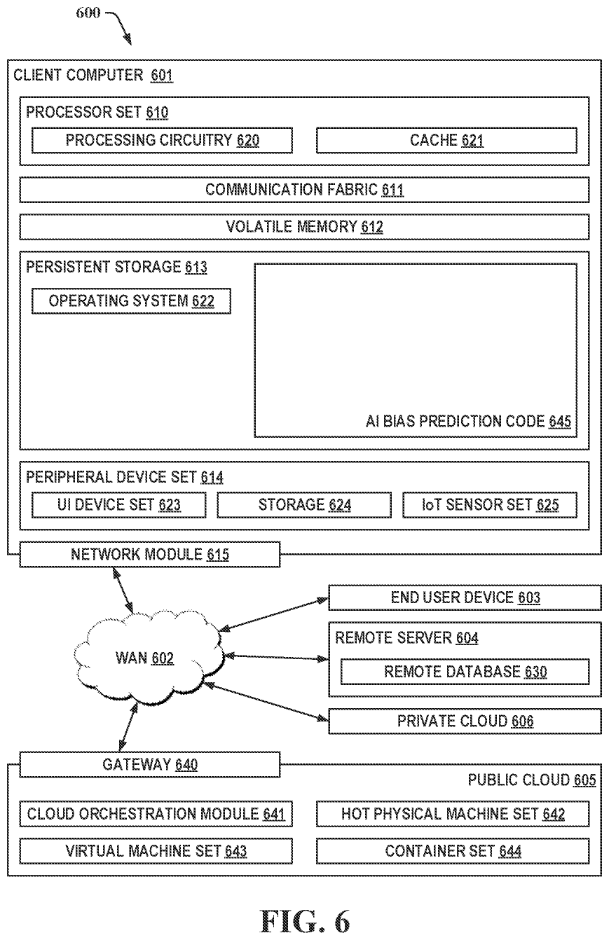

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 600 described below with reference to FIG. 6. For example, system 100 can be associated with a computing environment 600 such that aspects of processing can be distributed between system 100 and the computing environment 600.

In one or more embodiments, system 100 can enable prediction of bias in AI model 101 as well as generation of structured test data 119 to check for bias in AI model 101. AI component 114 can train two auto-encoders wherein a first auto-encoder (e.g., auto-encoder 206 of FIG. 2) can determine a first set of records for which AI model 101 can generate biased outputs and wherein a second auto-encoder (e.g., auto-encoder 208 of FIG. 2) can determine a second set of records for which AI model 101 can generate unbiased outputs. Training data 105 can be structured data used to train AI model 101, and the first auto-encoder (e.g., auto-encoder 206) and the second auto-encoder (e.g., auto-encoder 208) can also be trained based on training data 105. This can be achieved by dividing training data 105 into two groups wherein a first group can comprise biased records and a second group can comprise unbiased records. For example, individual records comprised in training data 105 can be perturbed and supplied to AI model 101, and the outcomes of AI model 101 for the individual records can be monitored.

For example, an AI model (e.g., AI model 101) employed in a banking environment for deciding whether a housing loan can be granted to individuals can be supplied with training data (e.g., training data 105) used to train the AI model, to detect bias in the AI model against individuals of a first social group versus individuals of a second social group. Herein, the group comprising the second social group can be considered as a majority group or reference group and the group comprising the first social group can be considered as a minority group or a monitored group. For example, the training data (e.g., training data 105) used to train the AI model (e.g., AI model 101) can comprise historical records of applicants to whom a housing loan was granted or denied by a bank, such that the training data can be divided into two distribution demographics of biased and unbiased groups, based on a fairness attribute of type of social group, for a first social group and second social group (i.e., two difference social groups or two different values). For example, a record comprised in the training data (e.g., training data 105) and belonging to an applicant of the second social group can be supplied as input to the AI model (e.g., AI model 101), and thereafter, the same record can be supplied as input to the AI model by changing the social group on the record to that of the monitored group, keeping other attributes of the record the same.

If the AI model (e.g., AI model 101) approves a housing loan for the unperturbed record belonging to the applicant of the second social group and denies the housing loan for the perturbed record wherein the social group was changed to that of the monitored group, it can indicate that the AI model (e.g., AI model 101) displays individual bias, that is, it can indicate that the AI model is biased towards the specific perturbed record wherein the social group was changed to the first social group. In this scenario, both the original (unperturbed) record and perturbed versions of the original records can be considered biased records. Contrarily, if the AI model (e.g., AI model 101) approves the housing loan for the unperturbed record wherein the social group of the applicant was changed to the first social group, both the original (unperturbed) record and the perturbed version of the original record can be considered unbiased records. Individual records of applicants from the monitored group comprised in the training data (e.g., training data 105) can also be supplied as input to the AI model (e.g., AI model 101), first as an unperturbed record wherein the social group remains unchanged, followed by changing the social group on the record to that of the reference group.

Thus, if the AI model (e.g., AI model 101) approves the housing loan for the unperturbed record and denies the housing loan for the perturbed version of the original record, the AI model can be described as displaying individual bias towards the record, since the perturbed and the unperturbed versions of a record can vary only by social group. Both the original record and the perturbed version of the original record can be considered biased records. The process of scoring the AI model (e.g., AI model 101) with individual records from the training data (e.g., training data 105) can be repeated for individual records in the training data. Based on the results of the AI model (e.g., AI model 101), two groups of records can be generated wherein a first group (e.g., a biased group) can comprise records from the training data (e.g., training data 105) for which the AI model generated biased outputs and a second group (e.g., an unbiased group) can comprise records from the training data for which the AI model generated unbiased outputs. It is to be appreciated that the social group values discussed herein are for exemplary purposes only, and one or more methods discussed herein are not restricted to specific social groups. As such, in one or more embodiments, other fairness attributes comprising, for example, ages of individuals, can also be considered for bias detection in an AI model since bias in AI models is not restricted to specific groups, and AI models can display bias at any time and for a variety of reasons.

As discussed in one or more embodiments herein, the group of biased records and the group of unbiased records can be respectively used to train the first auto-encoder (e.g., auto-encoder 206) and the second auto-encoder (e.g., auto-encoder 208) such that the first auto-encoder and the second auto-encoder can respectively detect biased and unbiased records based on an anomaly detection technique. For example, the first auto-encoder (e.g., auto-encoder 206) can be a neural network that can be trained using the group of biased records (e.g., biased records generated by AI model 101 from training data 105) such that when data similar to the training data of the first auto-encoder is fed to first auto-encoder, the first auto-encoder does not detect an anomaly, whereas when data dissimilar to the training data (i.e., unbiased records) is fed to the first auto-encoder, the first auto-encoder detects an anomaly. For example, upon detecting an input record as an anomaly, an auto-encoder (e.g., auto-encoder 206) can output a value of 1 on a display, indicating that an anomaly has been detected. For example, upon detecting an input record as not an anomaly, the auto-encoder (e.g., auto-encoder 206) can output a value of zero, indicating that no anomaly was detected. The second auto-encoder (e.g., auto-encoder 208) can be trained similarly wherein it can detect unbiased records as data that is similar to the training data of the second auto-encoder (e.g., unbiased records generated by AI model 101 from training data 105) and biased records as data that is dissimilar to the training data of the second auto-encoder.

Analysis component 108 can use auto-encoder 206 and auto-encoder 208 to analyze payload logging data 103. For example, analysis component 108 can use auto-encoder 206 to analyze payload logging data 103 to determine a first set of records in payload logging data 103, for which AI model 101 can generate biased outputs. For example, analysis component 108 can use auto-encoder 208 to analyze payload logging data 103 to determine a second set of records in payload logging data 103, for which AI model 101 can generate biased outputs. Payload logging data 103 can comprise runtime inputs 107 that AI model 101 can analyze upon being deployed for a runtime use case. In the exemplary banking scenario discussed herein, runtime inputs 107 can comprise runtime records of individuals seeking a housing loan. Runtime inputs 107 and the resulting outputs of the AI model (e.g., AI model 101) can be stored in a payload logging table as payload logging data 103.

An analysis component (e.g., analysis component 108) can use the first auto-encoder (e.g., auto-encoder 206) and the second auto-encoder (e.g., auto-encoder 208) to analyze the payload logging data (e.g., payload logging data 103) comprising runtime records of individuals seeking a housing loan. For example, the analysis component (e.g., analysis component 108) can feed a record from the payload logging data (e.g., payload logging data 103) to the first auto-encoder (e.g., auto-encoder 206), wherein if the first auto-encoder detects the record as an anomaly (using the anomaly detection technique), it can imply that the record is not biased. Thereafter, the analysis component (e.g., analysis component 108) can feed the same record to the second auto-encoder (e.g., auto-encoder 208), wherein if the second auto-encoder detects the record as non-anomalous, it can imply that the record is unbiased. Thus, individual records from the payload logging data (e.g., payload logging data 103) can be analyzed by the analysis component (e.g., analysis component 108) to divide the payload logging data into a biased distribution and an unbiased distribution. The biased distribution can comprise biased runtime records, that is, runtime records for which the AI model (e.g., AI model 101) unfairly denies the housing loan to individuals based on a social group attribute, and the unbiased distribution can comprise unbiased runtime records, that is, runtime records for which the AI model demonstrates fairness in approving the housing loan, regardless of the social group of an applicant.

The number of records in the biased distribution, and the number of records in the unbiased distribution can be monitored. If the number of records for which the AI model (e.g., AI model 101) denies the housing loan for individuals of the first social group continues to increase, the AI model can be inferred as being biased against individuals of the first social group (i.e., exhibiting group bias against the first social group). Alerting component 112 can alert a user of likelihood that AI model 101 will generate biased outputs at runtime in response to at least a quantity of records in the biased distribution approaching a defined threshold. For example, if the number of records for which the AI model (e.g., AI model 101) denies the housing loan for individuals of the first social group approaches a defined threshold, it can imply the AI model can be expected exhibit group bias during production, and an alerting component (e.g., alerting component 112) can generate an alert to a user. For example, if more than 50 records, resulting from the AI model's bias against individuals of the first social group in approving the housing loan, accumulate in the biased distribution in one week, the alerting component (e.g., alerting component 112) can generate an alert that the quantity of biased records under that category can be expected to approach a defined threshold (e.g., 75 records in one week). This can further imply that the AI model (e.g., AI model 101) can be expected to exhibit group bias against the first social group at runtime.

Herein, the threshold can be user defined based on the type of data being analyzed, type of predictions being made by an AI model, fairness attributes, etc. Monitoring component 116 can monitor the number of records in the biased distribution and the number of records in the unbiased distribution to enable computation of a disparate impact ratio (DIR) 117, wherein DIR 117 can be a metric for predicting whether AI model 101 can be expected to exhibit group bias at runtime. DIR 117 can be computed by computation component 118, wherein computation component 118 can further compute an estimated fairness score for AI model 101 based on an alert that DIR 117 is approaching the defined threshold. That is, monitoring component 116 can continuously monitor the outputs generated by auto-encoder 206 and auto-encoder 208 to enable computation of the DIR for AI model 101. Computation of DIR 117 can be based on a sliding window analysis (or moving window analysis). In the exemplary banking scenario discussed herein, for a fairness attribute of type of social group, the group comprising the second social group can be considered as a majority group or reference group and the group comprising the first social group can be considered as a minority group or a monitored group, and the DIR (e.g., DIR 117) can be calculated using equation 1.

$$DIR = \frac{\begin{matrix}percentage of favorable outcomes \\ in the minority group\end{matrix}}{\begin{matrix}percentage of favorable outcomes \\ in the majority group\end{matrix}} \qquad Equation 1$$

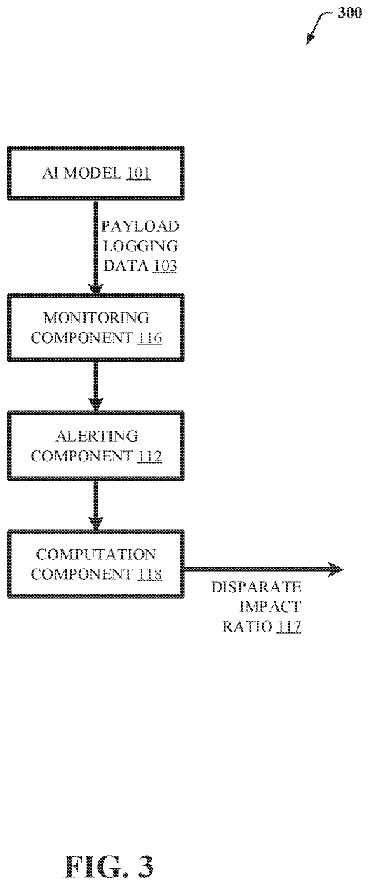

Determination of whether the AI model (e.g., AI model 101) can be expected to exhibit group bias at runtime can be achieved by two methods. For example, in a first method, the monitoring component (e.g., monitoring component 116) can monitor the number of individually biased records detected by the first auto-encoder (e.g., auto-encoder 206) for the majority and minority groups to detect if the AI model (e.g., AI model 101) is biased against the first social group for approving housing loans. In the second method, monitoring component 116 can directly monitor payload logging data 103, to enable computation of the DIR (e.g., DIR 117). In the second method, the monitoring component (e.g., monitoring component 116) can monitor the numerator and denominator of the DIR (e.g., DIR 117) to detect either a steady decline in the value of the numerator or a steady increase in the value of the denominator and to determine if the overall value of the DIR (e.g., DIR 117) is approaching a defined threshold. As discussed in one or more embodiments herein, if the overall value of the DIR (e.g., DIR 117) approaches the defined threshold, it can be inferred that the AI model (e.g., AI model 101) is expected to exhibit bias at runtime against the first social group for approving housing loans. The second method is further elaborated in FIG. 3 of this specification.

In an ideal world scenario, the DIR (e.g., DIR 117) for an AI model (e.g., AI model 101) would be 1, assuming that attributes other than the fairness attribute are consistent for individual records being analyzed. However, percentages of biased and unbiased outputs can vary in real-time. For example, the AI model (e.g., AI model 101) can be scored with 50 records belonging to individuals of the second social group and 50 records belonging to individuals of the first social group. If the AI model (e.g., AI model 101) approves the housing loan for 20 individuals of the monitored group and 30 individuals of the reference group, the DIR (e.g., DIR 117) according to equation 1 can be about 66.67, wherein the 66.67 can represent a quantitative measure of DIR. A user or developer of the AI model (e.g., AI model 101) can define a DIR threshold of 60 such that when the DIR value falls below 60 an alert can be generated by an alerting component (e.g., alerting component 112) that the AI model can be expected to exhibit group bias. In response to the advance alert, the AI model (e.g., AI model 101) can be removed from production and retrained by a data scientist, and the AI model can be subsequently tested for bias before deploying it for real time use cases. Following re-training of AI model 101, structured test data 119 can be generated by data generation component 110, specifically for checking bias in AI model 101. Structured test data 119 can be generated to ensure that AI model 101 is retrained to prevent AI model 101 from exhibiting bias at runtime.

For example, it can be possible that upon retraining AI model 101 on a test data set that is not specifically designed for bias checking, that AI model 101 can exhibit no bias during testing but demonstrate group bias upon being deployed in the market. Structured test data 119 can comprise a percentage of records from the biased group and the unbiased group of records respectively used to train auto-encoder 206 and auto-encoder 208. Structured test data 119 can further comprise a percentage of records from the biased distribution and the unbiased distribution respectively generated as a result of scoring auto-encoder 206 and auto-encoder 208 with payload logging data 103. The percentages of biased and unbiased records used for generating structured test data 119 can be user defined. If AI model 101 exhibits group bias during testing with structured test data 119, it can imply that AI model 101 can be expected to exhibit bias at runtime as well, because structured test data 119 can comprise a percentage of biased and unbiased records used to train AI model 101.

FIG. 2 illustrates an example, non-limiting flow-diagram 200 of a baseline distribution-based approach for predicting bias in an AI model in accordance with one or more embodiments described herein. While referring here to one or more processes, facilitations and/or uses of the non-limiting flow-diagram 200, descriptions provided herein, both above and below, also can be relevant to one or more other non-limiting systems described herein, such as the non-limiting system 100, to be described below in detail. Repetitive description of like elements and/or processes employed in respective embodiments is omitted for sake of brevity.

In one or more embodiments herein, system 100 can be employed to enable prediction of bias in AI model 101 via a baseline distribution-based approach illustrated in FIG. 2. Bias can be predicted for various fairness attributes such as nationality, age, ethnicity, or other social or non-social groups. The baseline distribution-based approach can require identification of baseline data 203 for predicting bias in AI model 101. Baseline data 203 can comprise training data 105 used to train AI model 101, test data used to test AI model 101, or payload logging data (e.g., payload logging data 103) received in production for one complete cycle of AI model 101, where the length of the cycle can be decided by the usage of the model (e.g., data received by AI model 101 in one week or one month). If training data 105 is unavailable or inaccessible, the test data used to test AI model 101 or payload logging data (e.g., payload logging data 103) can be used as baseline data 203.

Once baseline data 203 is identified and collected, identification of baseline data distribution can be performed to identify distributed baseline data 205. Identification of baseline data distribution can comprise identification of data distributions that cause AI model 101 to act in a biased manner. Identification of baseline data distribution identification can further comprise identification of data distributions that cause AI model 101 to act in an unbiased manner. Distributed baseline data 205 can comprise records from baseline data 203 that can cause AI model 101 to act in a biased manner as well as records from baseline data 203 that can cause AI model 101 to act in an unbiased manner. Distributed baseline data 205 can be identified by perturbing each individual record of baseline data 203 based on a fairness attribute, scoring AI model 101 with the individual records, and subsequently recording changes in outputs of AI model 101 from favorable to unfavorable or from unfavorable to favorable for the individual records. For example, baseline data 203 can comprise resumes of candidates seeking jobs and AI model 101 can be tested for prediction of bias towards a particular ethnicity. The ethnicity that AI model 101 can be unbiased towards can be described as a reference group, whereas other ethnicities can be collectively described as a monitored group.

The individual resumes of the candidates can be perturbed by changing the ethnicities on the original resumes from the reference group ethnicity to the monitored group ethnicity or vice-a-versa, and the perturbed and original records can be supplied to AI model 101 to record outcomes. If AI model 101 exhibits an unbiased outcome towards a resume belonging to the reference group by selecting candidates from the reference group for an interview, and if AI model 101 exhibits a biased outcome when the ethnicity on the resume is changed to one belonging to the monitored group, AI model 101 can be described as individually biased towards the resume. Further, both the original record and the perturbed record can be described as biased records. If AI model 101 does not exhibit bias upon changing the ethnicity, both the original record and the perturbed record can be described as unbiased records. Thus, individual records comprised in baseline data 203 can be perturbed and divided into a biased group and an unbiased group of records, wherein the biased and unbiased groups of records can comprise distributed baseline data 205.

The biased group of records from distributed baseline data 205 can be used to train auto-encoder 206 such that auto-encoder 206 can detect an unbiased record as an anomaly based on anomaly detection. Similarly, the unbiased group of records from distributed baseline data 205 can be used to train auto-encoder 208 such that auto-encoder 208 can detect a biased record as an anomaly. Thus, auto-encoder 206 and auto-encoder 208 can encode distribution of data where AI model 101 has or has not exhibited bias. As discussed in one or more embodiments herein, auto-encoder 206 and auto-encoder 208 can be used to analyze individual records from payload logging data 103 to identify the records for which AI model 101 is likely to exhibit bias at runtime. In the exemplary scenario discussed herein, a resume belonging to the monitored group can be supplied to auto-encoder 208 and if auto-encoder 208 detects the resume as an anomaly, it can be imply that the resume belonging to the monitored group is a biased record (i.e., a record towards which AI model 101 can exhibit bias at runtime). The resume can then be supplied to auto-encoder 206, wherein if auto-encoder 206 does not detect the resume as an anomaly, the resume can be described as a biased record.

Thus, individual records from distributed baseline data 205 can be divided into a biased distribution comprising one or more biased records and an unbiased distribution comprising one or more unbiased records. In the baseline distribution-based approach, monitoring component 116 can monitor the number of records in the biased distribution to track the number of individually biased outcomes that AI model 101 can exhibit towards individuals of both the reference group and the monitored group. Based on the monitoring, computation component 118 can compute an expected DIR value such that if the expected DIR value appears to cross a threshold, alerting component 112 can generate an alert to the user. For example, if the threshold on DIR 117 is set to 0.8, alerting component 112 can generate an alert to the user if the expected DIR value falls below 0.85. Based on the alert, computation of the actual DIR (e.g., DIR 117) based on a sliding window analysis can be triggered and an estimated fairness value for AI model 101 can be computed by computation component 118. Thereafter, corrective action can be taken by re-training AI model 101.

Upon re-training, AI model 101 can be tested for bias using structured test data 119. As discussed in one or more embodiments herein, structured test data 119 can comprise a percentage of records from the biased group and the unbiased group of records comprised in distributed baseline data 205. Structured test data 119 can further comprise a percentage of records from the biased distribution and the unbiased distribution respectively generated as a result of scoring auto-encoder 206 and auto-encoder 208 with payload logging data 103. The percentages of biased records and unbiased records comprised in structured test data 119 can be user defined. The baseline distribution-based approach combined with generating structured test data 119 specific for bias checking can make for a robust approach for bias checking in AI models (e.g., one or more of AI model 101).

FIG. 3 illustrates an example, non-limiting flow-diagram of a payload analysis-based approach for predicting bias in an AI model in accordance with one or more embodiments described herein. While referring here to one or more processes, facilitations and/or uses of the non-limiting flow-diagram 300, descriptions provided herein, both above and below, also can be relevant to one or more other non-limiting systems described herein, such as the non-limiting system 100, to be described below in detail. Repetitive description of like elements and/or processes employed in respective embodiments is omitted for sake of brevity.

In one or more embodiments herein, system 100 can be employed to enable prediction of bias in AI model 101 via a payload analysis-based approach illustrated in FIG. 3. Bias can be predicted for various fairness attributes such as nationality, age, ethnicity, or other social or non-social groups. In the payload analysis-based approach, monitoring component 116 can directly monitor payload logging data 103, to enable computation of the DIR (e.g., DIR 117). Based on monitoring of payload logging data 103, computation component 118 can compute total number of records for both minority (monitored) and majority (reference) groups, and computation component 118 can compute total number of records of both minority and majority groups for unbiased outcomes generated by AI model 101. The unbiased outcomes can also be described as favorable outcomes in one or more embodiments herein. Computation component 118 can use the information to further compute DIR 117 based on a sliding window analysis and a fairness score for AI model 101. For example, payload logging data 103 can comprises a total 80 records belonging to a monitored group and 90 records can belong to a reference group. AI model 101 can generate favorable outcomes (i.e., unbiased outcomes) for 40 records of the monitored group and for 75 records of the reference group. Thus, the DIR value based on the favorable outcomes and using equation 1 can be computed as:

$$DIR = \frac{\begin{matrix}percentage of favorable outcomes \\ in the minority group\end{matrix}}{\begin{matrix}percentage of favorable outcomes \\ in the majority group\end{matrix}} = \frac{\frac{40}{80} \times 100}{\frac{75}{90} \times 100}$$

The above calculation can result in a DIR value of about 0.6. Similar to the baseline distribution-based approach, if DIR 117 crosses a user-defined threshold, the user can be alerted by alerting component 112. For example, in the exemplary calculation presented herein, for a defined threshold of 0.5, an alert can be generated to the user when the DIR value falls below 0.55. A key difference between the baseline distribution-based approach discussed in FIG. 2 and the payload analysis-based approach discussed herein can be the perturbation of data. The payload analysis-based approach can directly utilize payload logging data 103 to determine whether AI model 101 can be expected to exhibit bias towards a particular group at runtime. The payload analysis-based approach can be executed without utilizing auto-encoders to compute a fairness score for AI model 101. That is, in the payload analysis-based approach, the estimated fairness score can be computed by computing a first percentage of unbiased outputs (e.g., unbiased outputs of a monitored group) generated by the AI model and a second percentage of unbiased outputs (e.g., unbiased outputs of a reference group) generated by the AI model, based on an unperturbed set of structured training data (e.g., training data 105). In the baseline distribution-based approach, the estimated fairness score can be computed by computing a quantity of biased outputs generated by the AI model and a quantity of unbiased outputs generated by the AI model, based on perturbation of individual records of a set of structured training data (e.g., training data 105).

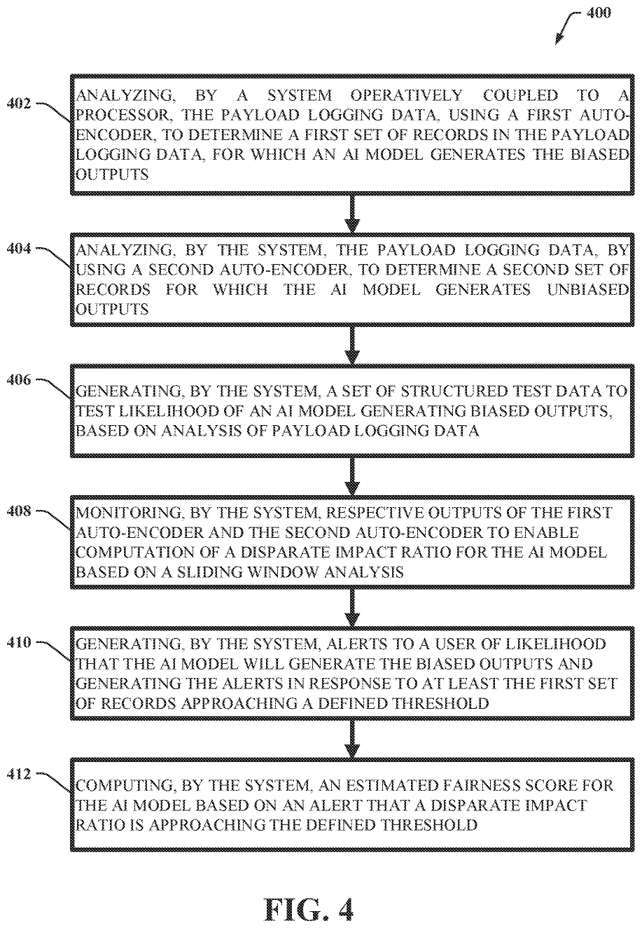

FIG. 4 illustrates a block diagram of an example, non-limiting method 400 for predicting future possibility of bias in an AI model in accordance with one or more embodiments described herein. Repetitive description of like elements and/or processes employed in respective embodiments is omitted for sake of brevity.

At 402, the non-limiting method 400 can comprise analyzing, by a system operatively coupled to a processor, the payload logging data, using a first auto-encoder, to determine a first set of records in the payload logging data, for which an AI model generates the biased outputs.

At 404, the non-limiting method 400 can comprise analyzing, by the system, the payload logging data, by using a second auto-encoder, to determine a second set of records for which the AI model generates unbiased outputs.

At 406, the non-limiting method 400 can comprise generating, by the system, a set of structured test data to test likelihood of an AI model generating biased outputs, based on analysis of payload logging data.

At 408, the non-limiting method 400 can comprise monitoring, by the system, respective outputs of the first auto-encoder and the second auto-encoder to enable computation of a disparate impact ratio for the AI model based on a sliding window analysis.

At 410, the non-limiting method 400 can comprise generating, by the system, alerts to a user of likelihood that the AI model will generate the biased outputs and generating the alerts in response to at least the first set of records approaching a defined threshold.

At 412, the non-limiting method 400 can comprise computing, by the system, an estimated fairness score for the AI model based on an alert that a disparate impact ratio is approaching the defined threshold.

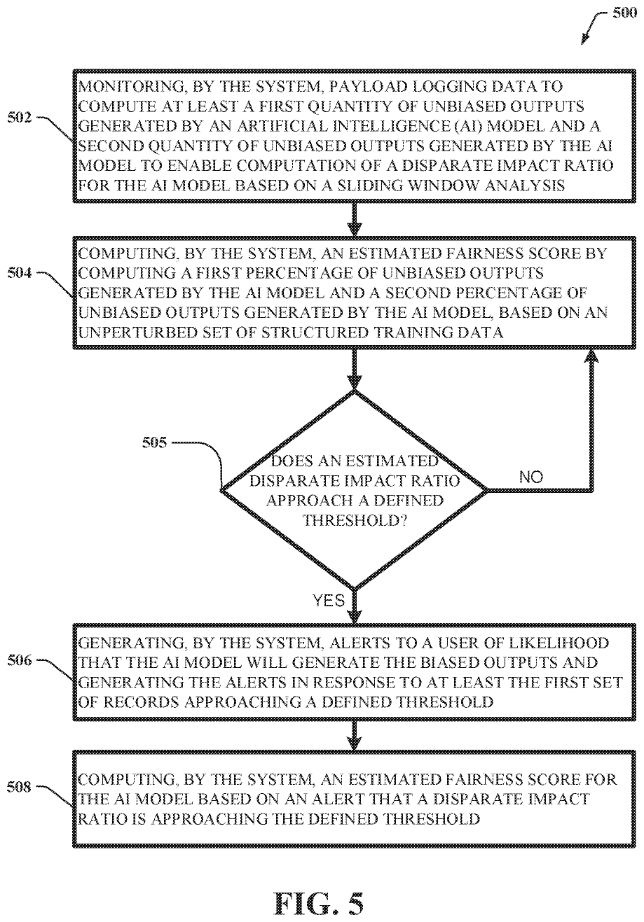

FIG. 5 illustrates a block diagram of an example, non-limiting method 500 for predicting future possibility of bias in an AI model in accordance with one or more embodiments described herein. Repetitive description of like elements and/or processes employed in respective embodiments is omitted for sake of brevity.

At 502, the non-limiting method 500 can comprise monitoring, by the system, payload logging data to compute at least a first quantity of unbiased outputs generated by an artificial intelligence (AI) model and a second quantity of unbiased outputs generated by the AI model to enable computation of a disparate impact ratio for the AI model based on a sliding window analysis.

At 504, the non-limiting method 500 can comprise computing, by the system, an estimated fairness score by computing a first percentage of unbiased outputs generated by the AI model and a second percentage of unbiased outputs generated by the AI model, based on an unperturbed set of structured training data.

At 505, the non-limiting method 500 can determine if an estimated disparate impact ratio approaches a defined threshold. If no, the non-limiting method 500 returns to 504 to continue computing the estimated fairness score. If yes, the non-limiting method 500 generates an alert at 506.

At 506, the non-limiting method 500 can comprise generating, by the system, alerts to a user of likelihood that the AI model will generate the biased outputs and generating the alerts in response to at least the first set of records approaching a defined threshold.

At 508, the non-limiting method 500 can comprise computing, by the system, an estimated fairness score for the AI model based on an alert that a disparate impact ratio is approaching the defined threshold.

### Terminology

Fairness attribute: The feature column on which the bias can be observed.

Reference group: The majority group for which the model can be expected to be biased.

Monitored group: The minority group for which the model can be expected to be biased against.

Group bias: Bias (by an AI model) against a particular group (e.g., against a particular ethnicity, nationality, or other social or non-social groups).

Disparate impact (or disparate impact ratio): A type of metric to measure group bias (see equation 1). Group bias can be measured via various other metrics.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively probe frequency space of a qubit as the one or more embodiments described herein can enable this process. And, neither can the human mind nor a human with pen and paper probe frequency space of a qubit, as conducted by one or more embodiments described herein.

FIG. 6 illustrates a block diagram of an example, non-limiting, operating environment in which one or more embodiments described herein can be facilitated. FIG. 6 and the following discussion are intended to provide a general description of a suitable operating environment 600 in which one or more embodiments described herein at FIGS. 1-5 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as AI bias prediction code 645. In addition to block 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 645, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A computer-implemented system, comprising:
a memory configured to store computer executable components; and
a processor configured to execute the computer executable components stored in the memory, wherein the computer executable components comprise:
a data generation component that generates a set of structured test data to test likelihood of an artificial intelligence (AI) model generating biased outputs, based on analysis of payload logging data; and
an alerting component that alerts a user of likelihood that the AI model will generate the biased outputs.

2. The computer-implemented system of claim 1, wherein the alerting component generates an alert to the user in response to at least a first set of records approaching a defined threshold.

3. The computer-implemented system of claim 1, further comprising:
an analysis component that analyzes the payload logging data, using a first auto-encoder, to determine a first set of records in the payload logging data, for which the AI model generates the biased outputs, wherein the set of structured test data comprises a percentage of at least the biased outputs.

4. The computer-implemented system of claim 3, further comprising:
an artificial intelligence (AI) component that trains the first auto-encoder to determine the first set of records for which the AI model generates the biased outputs.

5. The computer-implemented system of claim 3, wherein the AI component further trains a second auto-encoder to determine a second set of records in the payload logging data, for which the AI model generates unbiased outputs.

6. The computer-implemented system of claim 3, wherein the analysis component further analyzes the payload logging data, by using a second auto-encoder, to determine a second set of records for which the AI model generates unbiased outputs.

7. The computer-implemented system of claim 3, further comprising:
a monitoring component that monitors respective outputs of the first auto-encoder and a second auto-encoder to enable computation of a disparate impact ratio for the AI model based on a sliding window analysis.

8. The computer-implemented system of claim 1, wherein a computation component computes an estimated fairness score for the AI model based on an alert that a disparate impact ratio is approaching a defined threshold.

9. The computer-implemented system of claim 8, wherein the estimated fairness score is computed by computing a quantity of biased outputs generated by the AI model and a quantity of unbiased outputs generated by the AI model, based on perturbation of individual records of a set of structured training data.

10. The computer-implemented system of claim 8, wherein the estimated fairness score is computed by computing a first percentage of unbiased outputs generated by the AI model and a second percentage of unbiased outputs generated by the AI model, based on an unperturbed set of structured training data.

11. The computer-implemented system of claim 10, wherein the first percentage of unbiased outputs and the second percentage of unbiased outputs respectively represent a minority group and a majority group of payload logging data for which the AI model generates unbiased outputs.

12. A computer-implemented method, comprising:
generating, by a system operatively coupled to a processor, a set of structured test data to test likelihood of an AI model generating biased outputs, based on analysis of payload logging data; and
generating, by the system, alerts to a user of likelihood that the AI model will generate the biased outputs.

13. The computer-implemented method of claim 12, further comprising:
generating, by the system, an alert to the user in response to at least a first set of records approaching a defined threshold.

14. The computer-implemented method of claim 12, further comprising:
analyzing, by the system, the payload logging data, using a first auto-encoder, to determine a first set of records in the payload logging data, for which the AI model generates the biased outputs, wherein the set of structured test data comprises a percentage of at least the biased outputs.

15. The computer-implemented method of claim 14, further comprising:
analyzing, by the system, the payload logging data, by using a second auto-encoder, to determine a second set of records for which the AI model generates unbiased outputs.

16. The computer-implemented method of claim 14, further comprising:
monitoring, by the system, respective outputs of the first auto-encoder and a second auto-encoder to enable computation of a disparate impact ratio for the AI model based on a sliding window analysis.

17. The computer-implemented method of claim 12, further comprising:
computing, by the system, an estimated fairness score, by computing a quantity of the biased outputs generated by the AI model and a quantity of unbiased outputs generated by the AI model, based on perturbation of individual records of a set of structured training data.

18. The computer-implemented method of claim 12, further comprising:
computing, by the system, an estimated fairness score, by computing a first percentage of unbiased outputs generated by the AI model and a second percentage of unbiased outputs generated by the AI model, based on an unperturbed set of structured training data.

19. A computer program product for predicting bias in an AI model, the computer program product comprising a computer readable storage medium having program instructions embodied therewith, the program instructions executable by a processor to cause the processor to:
generate, by the processor, a set of structured test data to test likelihood of the AI model generating biased outputs, based on analysis of payload logging data; and
generate, by the processor, alerts to a user of likelihood that the AI model will generate the biased outputs.

20. The computer program product of claim 19, wherein the program instructions are further executable by the processor to cause the processor to:
generate, by the processor, an alert to the user in response to at least a first set of records approaching a defined threshold.
